(19) United States
(12) Patent Application Publication
(10) Pub. No.: US 2022/0097717 A1
(43) Pub. Date: Mar. 31, 2022

(54) OPERATING SOUND ESTIMATION DEVICE FOR VEHICLE ON-BOARD COMPONENT, OPERATING SOUND ESTIMATION METHOD FOR VEHICLE ON-BOARD COMPONENT, AND MEMORY MEDIUM

(71) Applicant: TOYOTA JIDOSHA KABUSHIKI KAISHA, Toyota-shi (JP)

(72) Inventors: Atsushi TABATA, Okazaki-shi (JP); Koichi OKUDA, Toyota-shi (JP); Ken IMAMURA, Toyota-shi (JP)

(73) Assignee: TOYOTA JIDOSHA KABUSHIKI KAISHA, Toyota-shi (JP)

(21) Appl. No.: 17/480,812

(22) Filed: Sep. 21, 2021

(30) Foreign Application Priority Data
Sep. 29, 2020 (JP) 2020-162975

(51) Int. Cl. B60W 40/12; G06N 3/04

(52) U.S. Cl. CPC B60W 40/12; G06N 3/04; B60W 2510/105; B60W 2510/1025; B60W 2510/0233

(57) ABSTRACT

An operating noise estimation device for a vehicle on-board component, an operating sound estimation method for a vehicle on-board component, and a memory medium are provided. The vehicle on-board component is operated by rotation that is output by a drive source of a vehicle. One of an independently-operating sound index value and a coupling-associated operating sound index value is an input-side index value, and the other one is an output-side index value. A neural network is trained using, for training data, a measurement value of the independently-operating sound index value and a measurement value of the coupling-associated operating sound index value for an individual vehicle on-board component. The execution device estimates, using the trained neural network, a value of the output-side index value of the vehicle on-board component in which the input-side index value is a specified value.

### BACKGROUND

### 1. Field

The present disclosure relates to an operating sound estimation device for a vehicle on-board component that estimates the magnitude of an operating sound of the vehicle on-board component. The present disclosure further relates to an operating sound estimation method for a vehicle on-board component and to a memory medium.

### 2. Description of Related Art

Vehicles include various vehicle on-board components that are operated by the rotation of a drive source, such as an engine or a motor. As disclosed in Japanese Laid-Open Patent Publication No. 2008-143348, such a vehicle on-board component may produce an operating sound when the vehicle is traveling. The operating sound is, for example, a gear noise caused by the meshing of gears.

It is desired that a vehicle on-board component be checked for its operating sound before the component is coupled to the vehicle. The operating sound check before the coupling is performed by measuring the operating sound in a state where the vehicle on-board component is operated independently.

However, the operating sound of the vehicle on-board component is produced very differently when the component is operated independently in a state where the component is not coupled to the vehicle and when the component is operated with the component coupled to the vehicle. Thus, when only checking the result of measuring the operating sound produced when the component is operated independently in the state where the component is not coupled to the vehicle, an accurate determination cannot be made as to whether a standard is satisfied by the operating sound produced when the component is operated with the component coupled to the vehicle.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Aspects of the present disclosure will now be described.

Aspect 1: An aspect of the present disclosure provides an operating sound estimation device for a vehicle on-board component. The vehicle on-board component is operated by rotation that is output by a drive source of a vehicle. The estimation device estimates a magnitude of an operating sound of the vehicle on-board component. The estimation device includes a memory device and an execution device. One of an independently-operating sound index value and a coupling-associated operating sound index value is an input-side index value, and the other one of the independently-operating sound index value and the coupling-associated operating sound index value is an output-side index value. The independently-operating sound index value is an index value of the magnitude of the operating sound obtained when the vehicle on-board component is operated independently. The coupling-associated operating sound index value being an index value of the magnitude of the operating sound obtained when the vehicle on-board component is operated with the vehicle on-board component coupled to the vehicle. The memory device of the operating noise estimation device for the vehicle on-board component stores a trained neural network. The trained neural network includes the input-side index value as an input and the output-side index value as an output. The trained neural network is trained using, for training data, a measured value of the independently-operating sound index value and a measured value of the coupling-associated operating sound index value for an individual vehicle on-board component. The execution device of the operating sound estimation device estimates, using the trained neural network, a value of the output-side index value of the vehicle on-board component in which the input-side index value is a specified value.

In the neural network trained using such training data, the relationship between the independently-operating sound index value and the coupling-associated operating sound index value of each individual vehicle on-board component is trained. The use of the neural network trained in this manner allows for proper management of the magnitude of the operating sound of the vehicle on-board component coupled to the vehicle by checking the operating sound of an independent vehicle on-board component prior to being coupled to the vehicle. For example, when the independently-operating sound index value is used as the input-side index value, the magnitude of the operating sound of the vehicle on-board component coupled to the vehicle is estimated from the result of measuring the magnitude of the operating sound of the vehicle on-board component that is operated independently and is not coupled to the vehicle. When the coupling-associated operating sound index value is used as the input-side index value, the magnitude of the operating sound of the vehicle on-board component coupled to the vehicle is used as a reference value to estimate the value of the operating sound of an individual vehicle on-board component that is operated independently and is not coupled to the vehicle. In either case, the result of measuring the operating sound of the component operated independently is used to determine whether the operating sound of the component coupled to the vehicle is greater than the reference value.

In one case, regardless of whether the background noise of the vehicle is large or small, the magnitude of the vehicle on-board component obtained when the vehicle on-board component is coupled to the vehicle is the same. Even in such a case, the operating sound of the vehicle on-board component is harder to recognize by the occupant or the like when the background noise of the vehicle is large than when the background noise of the vehicle is small. Thus, in Aspect 2, the difference between the sound pressure level of the operating sound of the vehicle on-board component and the sound pressure level of a background noise of the vehicle may be used as the coupling-associated operating sound index value.

In Aspect 3, the input of the trained neural network may include a state variable indicating a state of the vehicle. The training data may include a value of the state variable obtained when the coupling-associated operating sound index value is measured. In this case, the estimation of the output-side index value reflects a change, caused by the state of the vehicle, in the magnitude of the operating sound and in how easy the operating sound can be heard. In Aspect 4, the state variable may include one or more of an input rotation speed, an output rotation speed, an input torque, and an output torque of the vehicle on-board component. In Aspect 5, in the vehicle including a multi-stage transmission, a variable indicating the gear stage of the transmission may be a state variable. Further, in Aspect 6, in the vehicle including a lockup clutch, a variable indicating the engagement state of the lockup clutch may be a state variable. Furthermore, in Aspect 7, a variable indicating a warm-up state of the vehicle on-board component may be a state variable.

The operating sound of the vehicle on-board component is propagated to the auditory organ as the vibration of air when the vibration generated by the vehicle on-board component is transmitted to air. Thus, in Aspect 8, the independently-operating sound index value may include a value indicating a sound pressure level of the operating sound obtained when the vehicle on-board component is operated independently and a value indicating a vibration level of the vehicle on-board component obtained when the vehicle on-board component is operated independently.

Aspect 9 provides an operating sound estimation method for a vehicle on-board component that executes various processes according to any one of the above-described aspects.

Aspect 10 provides a non-transitory computer-readable memory medium that stores a program that causes an execution device to execute the various processes according to any one of the above-described aspects.

Other features and aspects will be apparent from the following detailed description, the drawings, and the claims.

### BRIEF DESCRIPTION OF THE DRAWINGS

FIG. 1 is a schematic diagram showing the configuration of an operating sound estimation device for a vehicle on-board component and a measurement device for an independently-operating sound index value according to a first embodiment.

FIG. 2 is a diagram showing how the coupling-associated operating sound is measured.

FIG. 3 is a graph showing how the coupling-associated sound pressure spike is calculated.

FIG. 4 is a schematic diagram showing the structure of the neural network used to estimate an operating sound in the operating sound estimation device.

FIG. 5 is a flowchart illustrating an operating sound check routine executed by the operating sound estimation device of the first embodiment.

FIG. 6 is a schematic diagram showing the structure of the neural network used to estimate an operating sound in the operating sound estimation device for the vehicle on-board component according to a second embodiment.

FIG. 7 is a flowchart illustrating a determination threshold value calculation routine executed by the operating sound estimation device of the second embodiment.

FIG. 8 is a graph showing the production region of the operating sound at each part of the automatic transmission.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

### First Embodiment

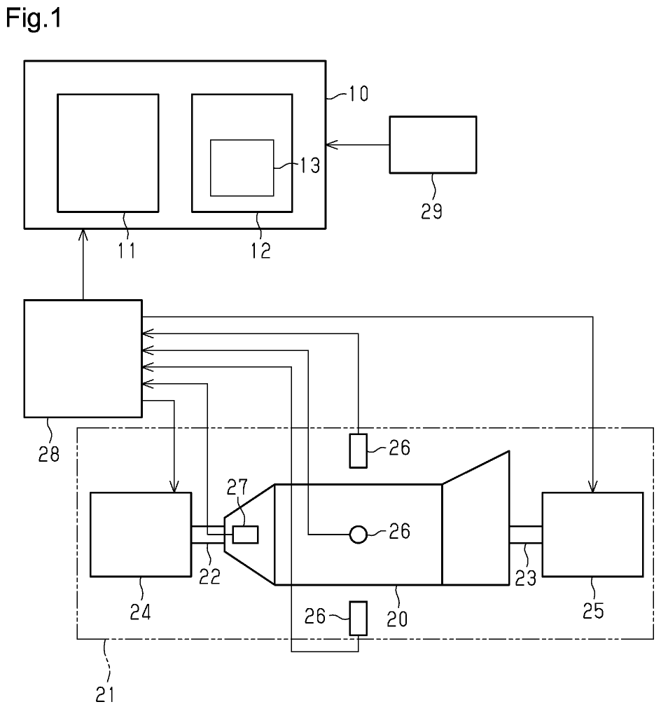

An operating sound estimation device 10 for a vehicle on-board component according to a first embodiment will now be described in detail with reference to FIGS. 1 to 5.

Configuration of Operating Sound Estimation Device

The operating sound estimation device 10 of the present embodiment shown in FIG. 1 estimates the operating sound of an automatic transmission 20. The automatic transmission 20 is one of the vehicle on-board components operated by rotation that is output by a drive source (such as an engine) of a vehicle. In the present embodiment, the operating sound of the automatic transmission 20 is estimated. The automatic transmission 20 includes a torque converter with a lockup clutch and includes a multi-stage transmission.

The operating sound estimation device 10 is an electronic computer. The operating sound estimation device 10 includes an execution device 11 and a memory device 12. The execution device 11 performs a calculation process that estimates an operating sound. The memory device 12 stores a neural network 13 used to estimate an operating sound. From the magnitude of the operating sound produced by independently operating the automatic transmission 20, the operating sound estimation device 10 of the present embodiment estimates the magnitude of the operating sound produced by operating the automatic transmission 20 coupled to the vehicle. In the following description, the operating sound of the automatic transmission 20 that is not coupled to the automatic transmission 20 and is used independently is referred to as the independently-operating sound. The operating sound of the automatic transmission 20 coupled to the automatic transmission 20 is referred to as the coupling-associated operating sound.

Measurement of Independently-Operating Sound

The measurement of the independently-operating sound will now be described with reference to FIG. 1. The independently-operating sound is measured with the automatic transmission 20 coupled to a motoring test device 21. The motoring test device 21 includes motors 24, 25 that are coupled to an input shaft 22 and an output shaft 23 of the automatic transmission 20, respectively. The motoring test device 21 performs output control for the two motors 24, 25 so as to set any operation conditions of the automatic transmission 20, such as an input rotation speed, an output rotation speed, an input torque, and an output torque of the automatic transmission 20.

The independently-operating sound is measured using a measurement device 28 that includes sound pressure sensors 26 and a vibration sensor 27. The sound pressure sensors 26 are located on positions that are separated from each other by a fixed distance from the surface of the automatic transmission 20. The vibration sensor 27 is located at a predetermined part of the automatic transmission 20. In the present embodiment, the vibration sensor 27 individually detects vibration and amplitude of three orthogonal axes.

The independently-operating sound is measured with the automatic transmission 20 operated in a preset operating condition in the motoring test device 21. The outputs of the sound pressure sensor 26 and the vibration sensor 27 during this operation are recorded by the measurement device 28. In the present embodiment, the measurement device 28 records an independently-operating sound pressure level, which is the sum of detection values of the sound pressure levels of the sound pressure sensors 26, as an independently-operating sound index value, which indicates the magnitude of an independently-operating sound. The measurement device 28 also measures, as the independently-operating sound index value, an independently-operating vibration level, which is the average value of the vibration and amplitude of the three orthogonal axes detected by the vibration sensor 27. The independently-operating sound index value is used for the estimation of the coupling-associated operating sound by the operating sound estimation device 10 and for the training of the neural network 13.

Measurement of Coupling-Associated Operating Sound

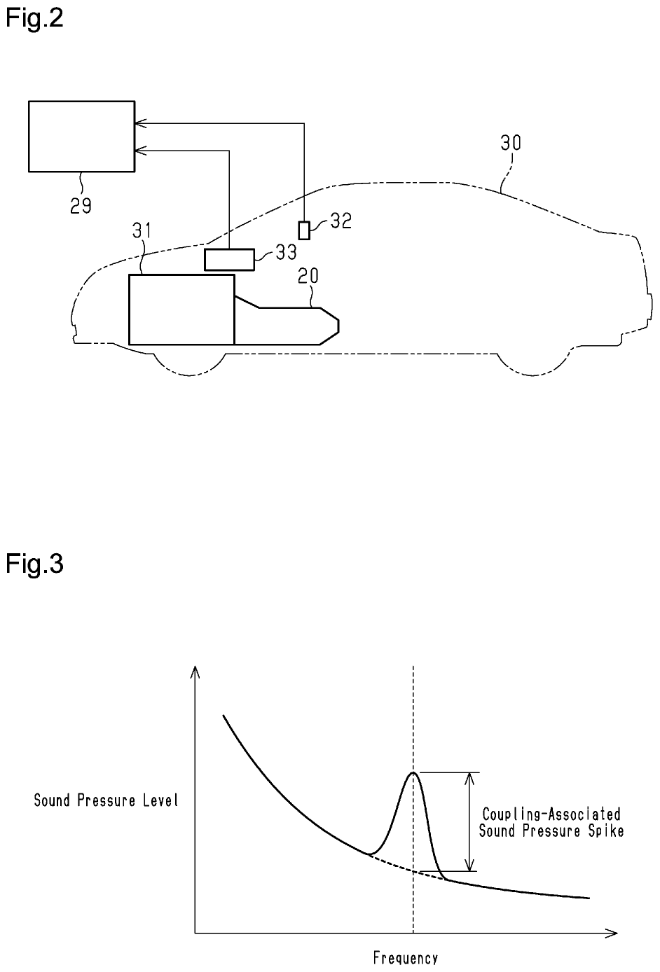

In the present embodiment, the coupling-associated operating sound is measured for the training of the neural network 13. The measurement of the coupling-associated operating sound will now be described with reference to FIG. 2.

FIG. 2 shows a vehicle 30 to which the automatic transmission 20 is coupled. The coupling-associated operating sound is measured with the automatic transmission 20 operated by a drive source 31 of the vehicle 30. In most types of the vehicle 30 currently used, one or both of an engine and a motor are used as the drive source 31. A sound pressure sensor 32 is connected to a measurement device 29 that measures the coupling-associated operating sound. The sound pressure sensor 32 is arranged in the vehicle 30 when the operating sound estimation device 10 is configured to estimate the magnitude of the operating sound of the automatic transmission 20 heard in the vehicle 30. The sound pressure sensor 32 is arranged outside the vehicle 30 when the operating sound estimation device 10 is configured to estimate the magnitude of the operating sound of the automatic transmission 20 heard outside the vehicle 30 while the vehicle 30 is traveling.

To measure the coupling-associated operating sound, the measurement device 29 is connected to a control unit 33 of the vehicle 30. When measuring the coupling-associated operating sound, the measurement device 29 obtains, from the control unit 33, the values of various state variables each indicating the state of vehicle 30. The state variables include variables that indicate the input rotation speed of the automatic transmission 20, the input torque of the automatic transmission 20, the gear stage of the automatic transmission 20, and an engagement state of the lockup clutch. The state variables also include a variable indicating a warm-up state of the automatic transmission 20. In the present embodiment, the value of the variable indicating the gear stage is set to 1 when the gear stage of the automatic transmission 20 is first gear, and the value of the variable indicating the gear stage is set to 2 when the gear stage of the automatic transmission 20 is second gear. In this manner, a variable that has a different numerical value for each gear stage is used as the variable indicating a gear stage. Further, in the present embodiment, the value of the variable indicating the engagement state is set to 0 when the lockup clutch is disengaged, and the value of the variable indicating the engagement state is set to 1 when the lockup clutch is semi-engaged. The value of the variable indicating the engagement state is set to 2 when the lockup clutch is completely engaged. In this manner, a variable that has a different numerical value for each engagement state of the lockup clutch is used as the variable indicating the engagement state of the lockup clutch. Furthermore, in the present embodiment, the temperature of coolant in the drive source 31 is used as the state variable indicating the warm-up state of the automatic transmission 20. The control unit 33 obtains the values of these state variables from the detection results of various sensors installed in vehicle 30.

The coupling-associated operating sound is measured with the automatic transmission 20 operated by rotation that is output by the drive source 31 of the vehicle 30. When measuring the coupling-associated operating sound, the measurement device 29 uses the detection result of the sound pressure sensor 32 to obtain a coupling-associated operating sound index value, which is an index value of the magnitude of the coupling-associated operating sound. The measurement device 29 records a value of the coupling-associated operating sound index value. The measurement device 29 obtains, from the control unit 33 of the vehicle 30, the value of each state variable being measured, and records the obtained value of the state variable being measured.

The sound pressure detected by the sound pressure sensor 32 includes the sound pressure of a background noise of the vehicle 30 in addition to the sound pressure of the operating sound of the automatic transmission 20. In the present embodiment, a coupling-associated sound pressure spike, which is the difference in sound pressure level between the operating sound of the automatic transmission 20 and the background noise of the vehicle 30, is used as the coupling-associated operating sound index value.

FIG. 3 shows an example of a frequency spectrum of the sound pressure level detected by the sound pressure sensor 32. Frequency components of the operating sound of the automatic transmission 20 concentrate in a specified frequency band. The background noise of the vehicle 30 includes various frequency components and has a sound pressure level that smoothly changes relative to the frequency. Thus, the frequency band of the operating sound of the automatic transmission 20 can be specified from the frequency spectrum. The sound pressure of a frequency band that differs from the frequency band of the operating sound of the automatic transmission 20 does not contain the operating sound of the automatic transmission 20 and contains only the background noise. Accordingly, the relationship between the sound pressure level and frequency in that frequency band containing only the background noise is used to estimate the sound pressure level of the background noise in the frequency band containing the operating sound of the automatic transmission 20. Therefore, the coupling-associated sound pressure spike can be obtained from the frequency spectrum of the sound pressure level detected by the sound pressure sensor 32.

Structure of Neural Network

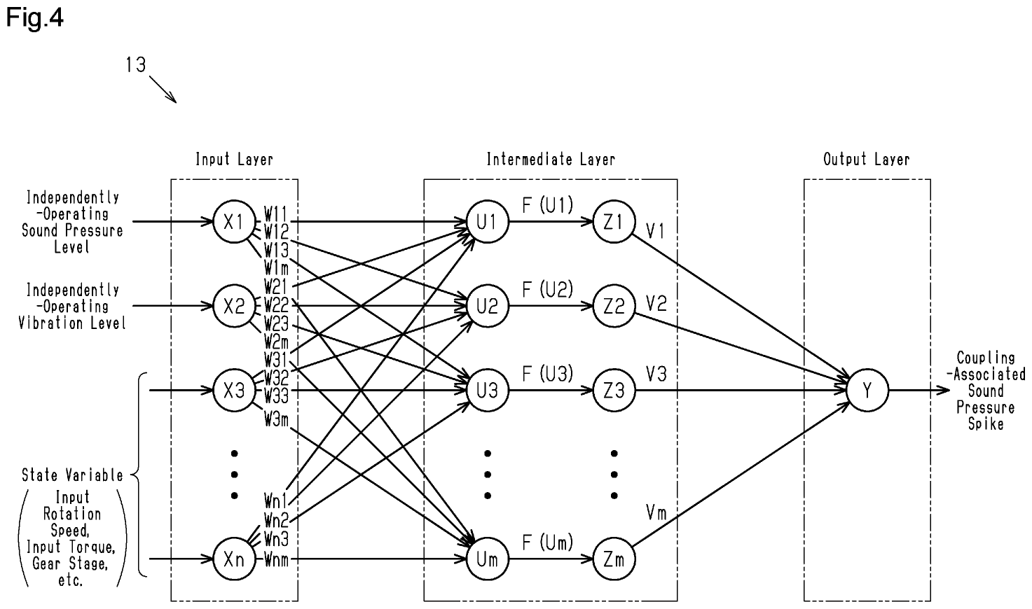

The structure of the neural network 13 used to estimate an operating sound will now be described with reference to FIG. 4. The neural network 13 includes an input layer including n nodes, an intermediate layer including m nodes, and an output layer including a single node. In the following description, i represents an integer greater than or equal to 1 and less than or equal to n (1≤i≤n), and j represents an integer greater than or equal to 1 and less than or equal to m (1≤j≤m).

In FIG. 4, the input values for the nodes of the input layer are represented as X1, X2, . . . , Xn. The input value X1 is an independently-operating sound pressure level. The input value X2 is an independently-operating vibration level. The remaining input values X3 to Xn are the state variables of the vehicle 30, such as the input rotation speed, input torque, and gear stage of the automatic transmission 20.

In FIG. 4, the input values for the nodes of the intermediate layer are represented as U1, U2, . . . , Um, and the output values for the nodes of the intermediate layer are represented as Z1, Z2, . . . , Zm. The input value Uj of each node of the intermediate layer is calculated as the sum of values that are obtained by multiplying an weight Wij by the input values X1, X2, . . . , Xn of the input layer. The output value Zj of each node of the intermediate layer is calculated as a return value of an activation function F in which the input value Uj of the node is an argument. In the present embodiment, the activation function F is a sigmoid function.

The output layer receives the sum of values that are obtained by multiplying a weight Vj by the output values Zj of the nodes of the intermediate layer. The values input to the output layer is directly calculated as an output value Y of the output layer. In the neural network 13, the coupling-associated sound pressure spike is used as the output value Y of the output layer.

The above-described neural network 13 includes, as inputs, the independently-operating sound pressure level, the independently-operating vibration level, and the state variables of the vehicle 30. The above-described neural network 13 further includes, as an output, the coupling-associated sound pressure spike obtained when the state variable of the vehicle 30 is input to the neural network.

Training of Neural Network

A method that generates the neural network 13 (i.e., the training of the neural network 13) will now be described. The training of the neural network 13 is performed using training data. The training data is created using the result of preliminary measurement of the independently-operating sound and coupling-associated operating sound for each individual automatic transmission 20. The training data consists of a large number of data sets. Each data set is a collection of the independently-operating sound pressure level, the independently-operating vibration level, the measured value of the coupling-associated sound pressure spike, and a value of the state variable of vehicle 30 obtained during the measurement of the coupling-associated sound pressure spike for the same individual automatic transmission 20. That is, each data set consists of n+1 values that correspond to the input values X1 to Xn of the input layer and the output value Y of the output layer in the neural network 13.

In the training of the neural network 13, the following process is performed for each data set. First, the measured value of the independently-operating sound pressure level, the measured value of the independently-operating vibration level, and the value of each state variable are input to the neural network 13 as values of the input values X1 to Xn. The values of the weights Wij, Vj are modified using backpropagation so as to reduce the error between the output value Y of the neural network 13 for the input and the value of the coupling-associated spike of the data set. Such a process that modifies the weights Wij, Vj is repeated until the error becomes less than or equal to a preset value. When the error becomes less than or equal to the preset value, the training of the neural network 13 is determined as being complete.

In the present embodiment, such a training process of the neural network 13 is performed by the execution device 11 of the operating sound estimation device 10. In the training of the neural network 13, the memory device 12 stores the above-described training data created from the result of measuring the independently-operating sound by the measurement device 28 and the result of measuring the coupling-associated operating sound by the measurement device 29. The training of the neural network 13 may be performed by a device that differs from the operating sound estimation device 10.

Operating Sound Check

The neural network 13 trained in this manner (trained neural network) is stored in the memory device 12 of the operating sound estimation device 10. The operating sound estimation device 10 of the present embodiment is used for an operating sound check of the automatic transmission 20, which is one of the checks conducted after the automatic transmission 20 is manufactured.

In the operating sound check, the measurement device 28 measures the independently-operating sound of the manufactured automatic transmission 20 (i.e., measures the independently-operating sound pressure level and the independently-operating vibration level). The measurement device 28 sets an input value Xt1 to the measured value of the independently-operating sound pressure level, sets an input value Xt2 to the measured value of the independently-operating vibration level, and sends the input values Xt1, Xt2 to the operating sound estimation device 10. The operating sound estimation device 10 uses the received input values Xt1, Xt2 to estimate the magnitude of the coupling-associated operating sound and uses the estimation result to determine whether the coupling-associated operating sound is acceptable or unacceptable. The standard of the acceptability determination is as follows. That is, the coupling-associated operating sound is determined as being acceptable when the coupling-associated sound pressure spike of the automatic transmission 20 is less than or equal to a given allowable upper limit YMAX at all of K preset operating points, and the coupling-associated operating sound is determined as being unacceptable when the coupling-associated sound pressure spike is greater than the allowable upper limit YMAX at one or more of K operating points. When the coupling-associated sound pressure spike becomes larger than a certain point, the occupant of the vehicle 30 recognizes the operating sound of the automatic transmission 20 as uncomfortable noise. In the present embodiment, the value of the allowable upper limit YMAX is set to a threshold value of the coupling-associated sound pressure spike that is used to determine whether the operating sound of the automatic transmission 20 is recognized as uncomfortable noise. The threshold value has been obtained through experiments in advance.

The memory device 12 of the operating sound estimation device 10 stores, in advance, the values of the state variables of the vehicle 30 at the above-described K operating points. In the following description, numbers 1 to K are given to K operating points to describe a first operating point, a second operating point, . . . , Kth operating point. The value of K represents the number of operating points that need the evaluation of the coupling-associated operating sound. To evaluate only the coupling-associated operating sound at a single operating point, the value of K is 1.

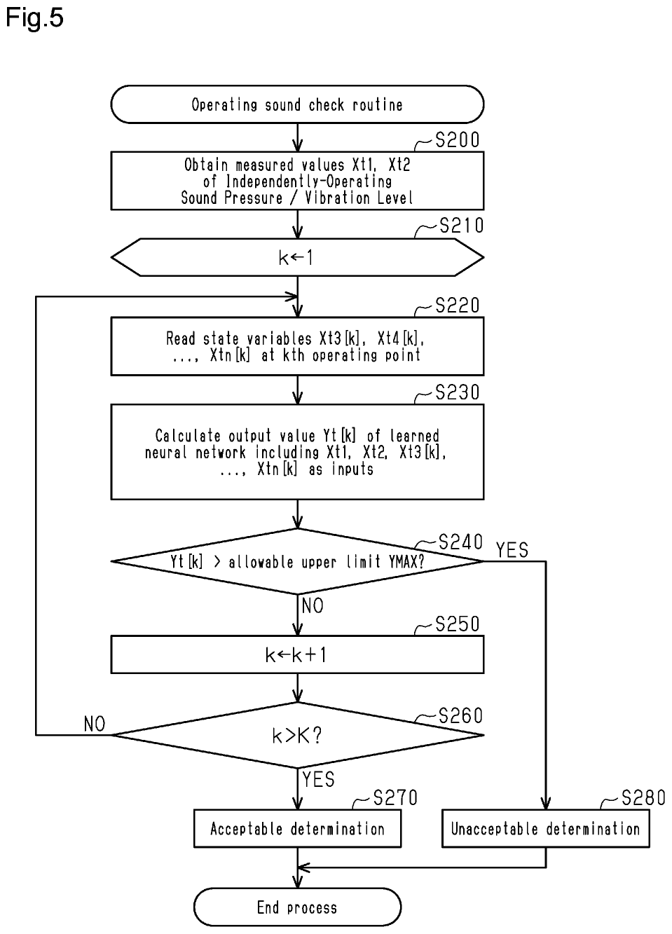

FIG. 5 shows the flowchart of an operating sound check routine executed by the execution device 11 for such an operating sound check. The execution device 11 starts the process of this routine when receiving the measured value of the independently-operating sound pressure level and the measured value of the independently-operating vibration level from the measurement device 28.

When this routine is started, in step S200, the execution device 11 first obtains the input value Xt1 (the measured value of the independently-operating sound pressure level) and the input value Xt2 (the measured value of the independently-operating vibration level) that were sent by the measurement device 28.

Subsequently, in the next step S210, the execution device 11 sets the value of variable k to 1. Then, the execution device 11 repeats a process loop from step S220 to step S260 until the determination result of whether the coupling-associated operating sound is acceptable or unacceptable is gained.

In step S220, the execution device 11 reads input values Xt3[k], Xt4[k], . . . , Xtn[k] from the memory device 12. Each of these values is the value of the state variable at kth operating point. In the next step S230, the execution device 11 calculates an output value Yt[k] of the neural network 13. The output value Yt[k] includes, as inputs, the input value Xt1 (the measured value of the independently-operating sound pressure level), the input value Xt2 (the measured value of the independently-operating vibration level), and the input values Xt3[k], Xt4[k], . . . , Xtn[k] (the values of the state variables at kth operating points). That is, in this step, the output value Yt[k] is calculated as an estimated value of the coupling-associated sound pressure spike at kth operating point.

Next, in step S240, the execution device 11 determines whether the output value Yt[k] is greater than the allowable upper limit YMAX. When the output value Yt[k] is greater than the allowable upper limit YMAX (S240: YES), the execution device 11 advances the process to step S280. In step S280, the execution device 11 determines that the result of the operating sound check of the individual automatic transmission 20 subject to the current check is unacceptable. Then, the execution device 11 ends the process of this routine.

When the output value Yt[k] is not greater than the allowable upper limit YMAX (S240: NO), the execution device 11 advances the process to step S250. In step S250, the execution device 11 increments the value of variable k. In step S260, the execution device 11 determines whether the value of the incremented variable k is greater than K. When the value of variable k is less than or equal to K (step S260: NO), the execution device 11 returns to the process of step S220. When the value of variable k is greater than K (step S260: YES), the execution device 11 advances the process to step S270. In step S270, the execution device 11 determines that the result of the operating sound check of the individual automatic transmission 20 subject to the current check is acceptable. Then, the execution device 11 ends the process of this routine.

In the above-described operating sound check routine, the coupling-associated sound pressure spike of each operating point using the neural network 13 is estimated in numerical order of the operating points. During the estimation, when a value greater than the allowable upper limit YMAX is calculated as the estimated value of the coupling-associated spike at any one of the operating points, the coupling-associated operating sound is determined as being unacceptable at that point in time, thereby ending the process of this routine. In contrast, when a value greater than the allowable upper limit YMAX is not calculated as the estimated value of the coupling-associated spike at any one of the operating points from the first to Kth points, the coupling-associated operating sound is determined as being acceptable.

Advantages of Embodiment

The operating sound estimation device 10 of the present embodiment provides the following advantages.

(1) The memory device 12 of the operating sound estimation device 10 of the present embodiment stores the neural network 13. The neural network 13 includes the independently-operating sound index value as an input. The independently-operating sound index value is an index value of the magnitude of the operating sound obtained when the automatic transmission 20 is operated independently. Further, the neural network 13 includes the coupling-associated operating sound index value as an output. The coupling-associated operating sound index value is an index value of the magnitude of the operating sound of the automatic transmission 20 coupled to the vehicle 30. The neural network 13 is trained using, for training data, the measured value of the independently-operating sound index value and the measured value of the coupling-associated operating sound index value for each individual automatic transmission 20. In the neural network 13 trained in this manner, the relationship between the independently-operating sound index value and the coupling-associated operating sound index value of each individual automatic transmission 20 is trained. The execution device 11 of the operating sound estimation device 10 of the present embodiment calculates, as the estimated value of the coupling-associated operating sound index value of the individual automatic transmission 20 in which the independently-operating sound index value is measured, the output value of the neural network 13 including the measured value of the independently-operating sound index value of the automatic transmission 20 as an input. Thus, the magnitude of the operating sound of the automatic transmission 20 coupled to the vehicle 30 can be estimated from the measurement result of the operating sound of the automatic transmission 20 used independently. That is, the magnitude of the operating sound of the automatic transmission 20 coupled to the vehicle 30 can be estimated before the automatic transmission 20 is coupled to the vehicle 30 in reality.

(2) The coupling-associated operating sound index value estimated in the above-described manner is used to determine whether the magnitude of the operating sound of the automatic transmission 20 obtained when the automatic transmission 20 is coupled to the vehicle 30 remains in an allowable range. This allows for determination of whether the magnitude of the operating sound of the automatic transmission 20 obtained when the automatic transmission 20 is coupled to the vehicle 30 remains in the allowable range before the automatic transmission 20 is coupled to the vehicle 30 in reality.

(3) In the present embodiment, the difference between the sound pressure level of the operating sound of the automatic transmission 20 and the sound pressure level of the background noise of the vehicle 30 is used as the coupling-associated operating sound index value. In one case, regardless of whether the background noise of the vehicle 30 is large or small, the magnitude of the automatic transmission 20 obtained when the automatic transmission 20 is coupled to the vehicle 30 is the same. In such a case, the operating sound of the automatic transmission 20 is harder for the occupant or the like to recognize when the background noise of the vehicle 30 is large than when the background noise of the vehicle 30 is small. Thus, the use of the difference in sound pressure level as the coupling-associated operating sound index value allows the operating sound check to be conducted, reflecting the influence of the background noise on the person's recognition of the operating sound.

(4) The inputs of the neural network 13 include the state variable indicating the state of the vehicle 30. Further, the training data used for the training of the neural network 13 includes the value of the state variable obtained when the coupling-associated operating sound index value is measured. This allows the coupling-associated operating sound index value to reflect changes, caused by the state of the vehicle 30, in the magnitude of the operating sound of the automatic transmission 20 and in how easy the operating sound of the automatic transmission 20 can be heard.

(5) The state variables serving as the inputs of the neural network 13 include variables that indicate the input rotation speed of the automatic transmission 20, the input torque of the automatic transmission 20, the gear stage of the automatic transmission 20, and the engagement state of the lockup clutch. As the operating state of the automatic transmission 20 indicated by these state variables changes, the magnitude of the operating sound produced by the automatic transmission 20 changes. This allows the estimated value of the coupling-associated operating sound index value to be calculated as a value that reflects a change in the operating sound caused by the operating state of the automatic transmission 20.

(6) The state variables serving as the inputs of the neural network 13 include the temperature of coolant in the drive source 31. When the automatic transmission 20 is not warmed up and the temperature of hydraulic oil in the automatic transmission 20 is low, the operating sound of the automatic transmission 20 may become large due to insufficient lubrication. The temperature of hydraulic oil in the automatic transmission 20 is low when the vehicle 30 is started. Then, the temperature of hydraulic oil in the automatic transmission 20 is gradually increased by, for example, frictional heat of an engaged element in the automatic transmission 20 during the traveling of the vehicle 30. In the same manner, the temperature of coolant in the drive source 31 is low when the vehicle 30 is started, and is gradually increased by the heat generated by the drive source 31 during the traveling of the vehicle 30. Thus, the temperature of coolant in the drive source 31 of the vehicle 30 is a parameter that correlates with the temperature of hydraulic oil in the automatic transmission 20 and ultimately correlates with the degree to which the warm-up of the automatic transmission 20 progresses. Thus, when the variable indicating such a warm-up state of the automatic transmission 20 is included in the state variables, the estimated value of the coupling-associated operating sound index value can be calculated as a value that reflects a change in the operating sound caused by the warm-up state of the automatic transmission 20.

(7) In the present embodiment, the independently-operating sound pressure level and the independently-operating vibration level are used as the independently-operating sound index values. The independently-operating sound pressure level is a value that indicates the sound pressure level of the operating sound of the automatic transmission 20 obtained when the automatic transmission 20 is operated independently. The independently-operating vibration level is a value that indicates the vibration level of the automatic transmission 20 obtained when the automatic transmission 20 is operated independently. The operating sound of the automatic transmission 20 is propagated to an auditory organ as the vibration of air when the vibration generated by the automatic transmission 20 is transmitted to air. Thus, the independently-operating sound pressure level and the independently-operating vibration level are the index values of the magnitude of the operating sound of the automatic transmission 20 when operated independently. Thus, the coupling-associated operating sound index value is estimated more accurately using the independently-operating sound pressure level and the independently-operating vibration level as the independently-operating sound index value.

### Second Embodiment

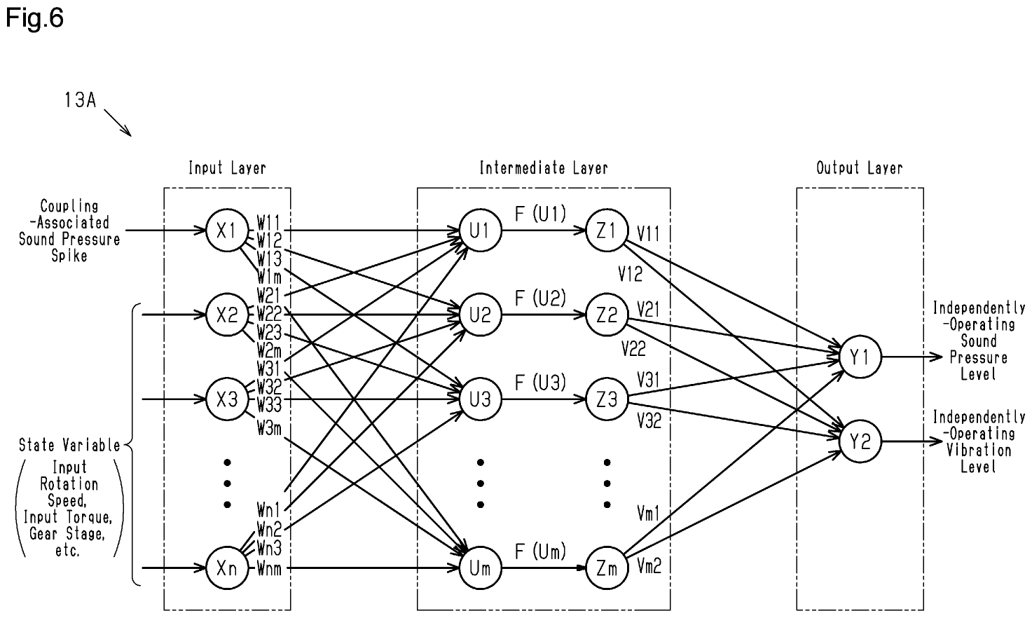

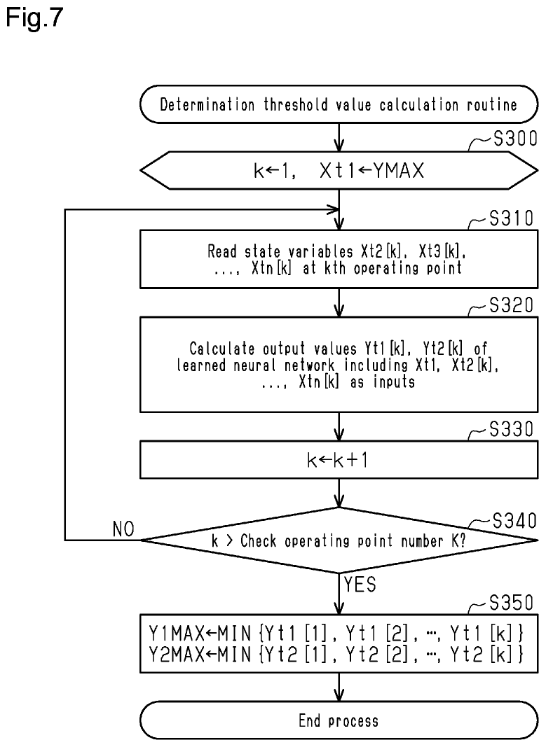

An operating sound estimation device for a vehicle on-board component according to a second embodiment will now be described in detail with reference to FIGS. 6 and 7. In the present embodiment, the same reference numerals are given to those components that are the same as the corresponding components of the above-described embodiment and a detailed description thereof is omitted.

The operating sound estimation device of the present embodiment has the same configuration as the operating sound estimation device 10 of the first embodiment shown in FIG. 1. The present embodiment differs from the first embodiment in the configuration of the neural network 13 stored in the memory device 12.

Neural Network

FIG. 6 shows a neural network 13A used for the operating sound estimation device of the present embodiment. The neural network 13A includes an input layer including n nodes, an intermediate layer including m nodes, and an output layer including two nodes. As described above, i represents an integer greater than or equal to 1 and less than or equal to n, and j represents an integer greater than or equal to 1 and less than or equal to m.

The input value X1 of the input layer in the neural network 13A is the coupling-associated sound pressure spike. The remaining input values X2 to Xn in the input layer are the state variables of the vehicle 30. The output value Y1 of the output layer of the neural network 13A is the independently-operating sound pressure level. The output value Y2 is the independently-operating vibration level.

In FIG. 6, the input value Uj of each node of the intermediate layer is calculated as the sum of values that are obtained by multiplying the weight Wij by the input values X1, X2, . . . , Xn of the input layer. The output value Zj of each node of the intermediate layer is calculated as a return value of the activation function F in which the input value Uj of the node is an argument. The sum of values that are obtained by multiplying a weight Vj1 by the output values Zj of the nodes of the intermediate layer are input to the node in which the output value Y1 is the independently-operating sound pressure level, of the two nodes of the output layer. The sum of values that are obtained by multiplying a weight Vj2 by the output values Zj of the nodes of the intermediate layer is input to the node in which the output value Y2 is the independently-operating vibration level. In the two nodes of the output layer, the input values are directly calculated as the output values Y1, Y2. The neural network 13A having the above-described configuration includes the coupling-associated operating sound index value as an input and the independently-operating sound index value as an output.

In the second embodiment, of the two index values, (i.e., the independently-operating sound index value and the coupling-associated operating sound index value), the index value serving as an input of the neural network is referred to as the input-side index value and the index value serving as an output of the neural network is referred to as the output-side index value. In the neural network 13 of the first embodiment shown in FIG. 4, the input-side index value is the independently-operating sound index value, and the output-side index value is the coupling-associated operating sound index value. In the neural network 13A of the first embodiment shown in FIG. 6, the input-side index value is the coupling-associated operating sound index value, and the output-side index value is the independently-operating sound index value.

The training of the neural network 13A is performed using the same training data as the training data of the first embodiment. That is, the training data consists of a large number of data sets. Each data set is a collection of the independently-operating sound pressure level, the independently-operating vibration level, the measured value of the coupling-associated sound pressure spike, and a value of the state variable of vehicle 30 obtained during the measurement of the coupling-associated sound pressure spike for the same individual automatic transmission 20.

In the training of the neural network 13A, the following process is performed for each data set of the training data. First, the measured value of the independently-operating sound pressure level in the data set and the values of the state variables are set to values of the input values X1 to Xn and input to the neural network 13A. The values of the weights Wij, Vj1, Vj2 are modified using backpropagation so as to reduce the error between the output value Y1 of the neural network 13A for the input and the value of the independently-operating sound pressure level in the data set and reduce the error between the output value Y2 of the neural network 13A and the value of the independently-operating vibration level. Such a process that modifies the weights Wij, Vj1, Vj2 is repeated until the two errors become less than or equal to a preset value. When the two errors become less than or equal to the preset value, the training of the neural network 13A is determined as being complete.

Operating Sound Check

The neural network 13A trained in this manner is used to calculate a determination threshold value of the independently-operating sound pressure level and a determination threshold value of the independently-operating vibration level that serve as the acceptability standard of the operating sound check conducted after manufacturing of the automatic transmission 20. More specifically, at all K operating points of the automatic transmission 20, the neural network 13A is used to calculate, as the determination threshold value of the independently-operating sound pressure level and the determination threshold value of the independently-operating vibration level, a value in which the coupling-associated sound pressure spike is less than or equal to the allowable upper limit YMAX.

FIG. 7 shows the flowchart of a determination threshold value calculation routine executed by the execution device 11 to calculate the determination threshold values. When this routine is started, in step S300, the execution device 11 first sets the value of variable k to 1 and sets the value of the input value Xt1 to the allowable upper limit YMAX of the coupling-associated sound pressure spike.

Next, in step S310, the execution device 11 reads, as the values of input values Xt2[k] to Xtn[k], the value of each state variable of kth operating point stored in advance in the memory device 12. Subsequently, in step S320, the execution device 11 calculates output values Yt1[k], Yt2[k] of the neural network 13A that includes the input values Xt1, Xt2[k], Xt3[k], . . . , Xtn[k] as inputs. The value of the calculated output value Yt1[k] is the estimated value of the independently-operating sound pressure level in which the coupling-associated sound pressure spike at the kth operating point is the allowable upper limit YMAX. The value of the output value Yt2[k] is the estimated value of the independently-operating sound pressure level in which the coupling-associated sound pressure spike at the kth operating point is the allowable upper limit YMAX.

Subsequently, in step S330, the execution device 11 increments the value of variable k. In the next step S340, the execution device 11 determines whether the value of the incremented variable k is greater than K. When the value of variable k is not greater than K (step S340: NO), the execution device 11 returns the process to step S310 and executes the processes of S310 to S340 again. That is, in this routine, the process loop of steps S310 to S340 is executed K times. By executing the process loop K times, the estimated value of the independently-operating sound pressure level and the estimated value of the independently-operating vibration level in which the coupling-associated sound pressure spike is the allowable upper limit YMAX is calculated at each of K operating points.

When the value of variable k is greater than K (step S340: YES), the execution device 11 advances the process to step S350. In step S350, the execution device 11 sets the value of a determination threshold value Y1MAX of the independently-operating sound pressure level to the minimum value of K output values Yt1[1], Yt1[2], . . . , Yt1[k] calculated by repeating the process loop. In step S350, the execution device 11 also sets the value of a determination threshold value Y2MAX of the independently-operating vibration level to the minimum value of K output values Yt2[1], Yt2[2], . . . , Yt2[k] calculated by repeating the process loop. Then, the execution device 11 ends the process of this routine.

In the above-described determination threshold value calculation routine, the value of the determination threshold value Y1MAX is set to the maximum value of the independently-operating sound pressure level in which the coupling-associated sound pressure spike is less than or equal to the allowable upper limit YMAX at all of K operating points. Further, the value of the determination threshold value Y2MAX is set to the maximum value of the independently-operating vibration level in which the coupling-associated sound pressure spike is less than or equal to the allowable upper limit YMAX at all of K operating points.

In the present embodiment, the determination threshold values Y1MAX, Y2MAX set in this manner are used to conduct the operating sound check after manufacturing of the automatic transmission 20. After the automatic transmission 20 is manufactured, the operating sound check first measures the independently-operating sound pressure level and the independently-operating vibration level. Then, the following manner is employed to determine whether the operating sound is acceptable or unacceptable. That is, the operating sound is determined as being acceptable when the condition that the measured value of the independently-operating sound pressure level is less than or equal to the determination threshold value Y1MAX and the condition that the measured value of the independently-operating vibration level is less than or equal to the determination threshold value Y2MAX are both satisfied, and the operating sound is determined as being unacceptable when one or both of these conditions are not satisfied. In this manner, in the present embodiment, the operating sound check for the automatic transmission 20 is conducted in reference to the estimation result of the independently-operating sound index value using the neural network 13A.

The operating sound estimation device for the vehicle on-board component in the present embodiment provides the above-described advantages (1) to (7).

The above-described embodiment may be modified as follows. The above-described embodiments and the following modifications can be combined as long as the combined modifications remain technically consistent with each other.

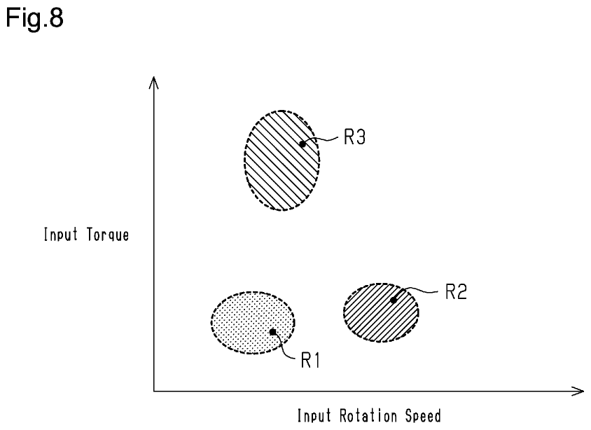

The automatic transmission 20 including a large number of components may include multiple production parts, where an operating sound is produced. The mechanism of producing the operating sound may be different between the production parts. In such a case, if the measured value of the coupling-associated operating sound index value used for training data is mixed with the measured value of the operating sound generated in different parts, the training of the neural network 13, 13A may not be able to be performed properly. As a result, the accuracy of estimating the operating sound may be lowered. The operating condition of the automatic transmission 20 that produces the operating sound may be different between the production parts. In FIG. 8, production regions R1 to R3 that respectively correspond to the operating sounds in the production parts of three operating sounds in the automatic transmission 20 are plotted on a three-axis orthogonal coordinate system of which the axes are the input rotation speed and input torque of the automatic transmission 20. When the production regions R1 to R3 of the operating sounds in the production parts are separated from each other in this manner, the coupling-associated operating sound index value can be measured for each production part. A neural network simply needs to be arranged individually for each production part so that the training of each neural network is performed for the corresponding production part.

In the above-described embodiments, the neural network 13, 13A includes one intermediate layer. Instead, the neural network 13, 13A may include two or more intermediate layers.

In the above-described embodiments, a sigmoid function is used as the activation function of the neural network 13, 13A. Instead, a function other than a sigmoid function may be used as the activation function.

In the above-described embodiments, the temperature of coolant in the drive source 31 is used as the state variable indicating the warm-up state of the automatic transmission 20. Instead, a parameter other than the temperature of coolant in the drive source 31 may be used as the state variable indicating the warm-up state of the automatic transmission 20. For example, when the temperature of hydraulic oil in the automatic transmission 20 can be directly measured, the measured value of the hydraulic oil in the automatic transmission 20 can be used as the state variable indicating the warm-up state of the automatic transmission 20. Alternatively, the travel distance or elapsed time after the vehicle 30 is started can be used as the state variable indicating the warm-up state of the automatic transmission 20.

In the above-described embodiments, the sum of the detection values of sound pressure levels of three sound pressure sensors 26 is used as the value of the independently-operating sound pressure level. The manner of calculating the independently-operating sound pressure level using the detection value of the sound pressure level may be changed. For example, the average value of the detection values of the sound pressure levels of the sound pressure sensors 26 may be calculated as the value of the independently-operating sound pressure level. Additionally, the number of the sound pressure sensors 26 used may be changed.

In the above-described embodiments, the average value of the vibration and amplitude in the three directions detected by the vibration sensor 27 is calculated as the value of the independently-operating vibration level. The manner of calculating the independently-operating vibration level using the detection value of the vibration sensor 27 may be changed. For example, the sum of the vibration and amplitude in the three directions may be calculated as the value of the independently-operating vibration level. Further, the vibration sensor 27 may be, for example, a sensor that detects the vibration and amplitude in a single direction or a sensor that detects the acceleration in a single direction.

In the above-described embodiments, two values (i.e., the independently-operating sound pressure level and the independently-operating vibration level) are used as the independently-operating sound index value. Instead, only one of them may be used as the independently-operating sound index value. Alternatively, the independently-operating sound index value may be a value other than the independently-operating sound pressure level and the independently-operating vibration level as long as that value is obtained from the measurement result of the operating sound of the automatic transmission 20 used independently.

The coupling-associated operating sound index value may be a value other than the coupling-associated sound pressure spike obtained from the measurement result of the automatic transmission 20 coupled to vehicle 30. For example, to evaluate the magnitude of an operating sound, the sound pressure level of the operating sound of the automatic transmission 20 coupled to the vehicle 30 may be directly used as the coupling-associated operating sound index value.

In the above-described embodiments, the coupling-associated operating sound index value is obtained from the measurement result of the sound pressure level in the passenger compartment. To evaluate the magnitude of the operating sound of the automatic transmission 20 reaching the outside of the vehicle, the sound pressure sensor 32 may be arranged outside the vehicle so as to measure the coupling-associated operating sound.

In the above-described embodiments, one of the state variables serving as inputs of the neural network 13, 13A is the input rotation speed of the automatic transmission 20. Instead, the output rotation speed of the drive source 31 or the output rotation speed of the automatic transmission 20 may be used. Further, in the above-described embodiments, one of the state variables serving as inputs of the neural network 13, 13A is the input torque of the automatic transmission 20. Instead, the output torque of the drive source 31 or the output torque of the automatic transmission 20 may be used.

The type and number of state variables serving as inputs of the neural network 13, 13A may be changed. Further, the neural network 13, 13A do not have to include a state variable as an input. That is, the neural network 13 may include only the independently-operating sound index value as an input, and the neural network 13A may include only the coupling-associated operating sound index value as an input.

In the above-described embodiments, the estimation result of an operating sound using the neural network 13, 13A is employed for the operating sound check after manufacturing of automatic transmission 20. The estimation result of the operating sound may be used for other purposes.

In the above-described embodiments, the operating sound of the automatic transmission 20 is estimated. The operating sound estimation device may be configured to estimate the operating sound of a vehicle on-board component other than the automatic transmission 20 as long as the vehicle on-board component is operated by rotation that is output by the drive source 31 of the vehicle 30. The vehicle on-board component operated by the rotation output by the drive source 31 is, for example, a differential or a transfer case.

The execution device is not limited to a device that includes a CPU and a ROM and executes software processing, but is not limited to this configuration. For example, the execution device may include dedicated hardware circuits (such as ASIC) that executes at least part of the processes using the software in the above-described embodiments. That is, the execution device may be modified as long as it has any one of the following configurations (a) to (c): (a) a configuration including a processor that executes all of the above-described processes according to programs and a program storage device such as a ROM (including a non-transitory computer readable memory medium) that stores the programs. (b) a configuration including a processor and a program storage device that execute part of the above-described processes according to the programs and a dedicated hardware circuit that executes the remaining processes; and (c) a configuration including a dedicated hardware circuit that executes all of the above-described processes. A plurality of software execution devices each including a processor and a program storage device and a plurality of dedicated hardware circuits may be provided.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. An operating sound estimation device for a vehicle on-board component, the vehicle on-board component being operated by rotation that is output by a drive source of a vehicle, the operating sound estimation device being configured to estimate a magnitude of an operating sound of the vehicle on-board component,
the operating sound estimation device comprises:
a memory device; and
an execution device, wherein
one of an independently-operating sound index value and a coupling-associated operating sound index value is an input-side index value and the other one of the independently-operating sound index value and the coupling-associated operating sound index value is an output-side index value, the independently-operating sound index value being an index value of the magnitude of the operating sound obtained when the vehicle on-board component is operated independently, the coupling-associated operating sound index value being an index value of the magnitude of the operating sound obtained when the vehicle on-board component is operated with the vehicle on-board component coupled to the vehicle,
the memory device stores a trained neural network,
the trained neural network includes the input-side index value as an input and the output-side index value as an output,
the trained neural network is trained using, for training data, a measured value of the independently-operating sound index value and a measured value of the coupling-associated operating sound index value for an individual vehicle on-board component, and
the execution device is configured to estimate, using the trained neural network, a value of the output-side index value of the vehicle on-board component in which the input-side index value is a specified value.

2. The operating sound estimation device according to claim 1, wherein the execution device is configured to use, as the coupling-associated operating sound index value, a difference between a sound pressure level of the operating sound and a sound pressure level of a background noise of the vehicle.

3. The operating sound estimation device according to claim 1, wherein
the input of the trained neural network includes a state variable indicating a state of the vehicle, and
the training data includes a value of the state variable obtained when the coupling-associated operating sound index value is measured.

4. The operating sound estimation device according to claim 3, wherein the state variable includes one or more of an input rotation speed, an output rotation speed, an input torque, and an output torque of the vehicle on-board component.

5. The operating sound estimation device according to claim 3, wherein
the vehicle includes a multi-stage transmission, the multi-stage transmission providing a gear stage, and
the state variable includes a variable indicating the gear stage of the transmission.

6. The operating sound estimation device according to claim 3, wherein
the vehicle includes a lockup clutch, and
the state variable includes a variable indicating an engagement state of the lockup clutch.

7. The operating sound estimation device according to claim 3, wherein the state variable includes a variable indicating a warm-up state of the vehicle on-board component.

8. The operating sound estimation device according to claim 1, wherein the independently-operating sound index value includes a value indicating a sound pressure level of the operating sound obtained when the vehicle on-board component is operated independently and a value indicating a vibration level of the vehicle on-board component obtained when the vehicle on-board component is operated independently.

9. An operating sound estimation method for a vehicle on-board component, the vehicle on-board component being operated by rotation that is output by a drive source of a vehicle, the operating sound estimation method comprising:
using, by an execution device, a trained neural network stored by a memory device, the trained neural network including an input-side index value as an input and an output-side index value as an output, the trained neural network being trained using, for training data, a measured value of an independently-operating sound index value and a measured value of a coupling-associated operating sound index value for an individual vehicle on-board component, one of the independently-operating sound index value and the coupling-associated operating sound index value being the input-side index value and the other one of the independently-operating sound index value and the coupling-associated operating sound index value being the output-side index value, the independently-operating sound index value being an index value of a magnitude of an operating sound obtained when the vehicle on-board component is operated independently, the coupling-associated operating sound index value being an index value of the magnitude of the operating sound obtained when the vehicle on-board component is operated with the vehicle on-board component coupled to the vehicle; and
estimating, by the execution device, using the trained neural network, a value of the output-side index value of the vehicle on-board component in which the input-side index value is a specified value in order to estimate the magnitude of the operating sound of the vehicle on-board component.

10. A non-transitory computer-readable medium that stores a program for causing an execution device to execute an operating sound estimation process for a vehicle on-board component, the vehicle on-board component being operated by rotation that is output by a drive source of a vehicle, the operating sound estimation process comprising:
using, by the execution device, a trained neural network stored by a memory device, the trained neural network including an input-side index value as an input and an output-side index value as an output, the trained neural network being trained using, for training data, a measured value of an independently-operating sound index value and a measured value of a coupling-associated operating sound index value for an individual vehicle on-board component, one of the independently-operating sound index value and the coupling-associated operating sound index value being the input-side index value and the other one of the independently-operating sound index value and the coupling-associated operating sound index value being the output-side index value, the independently-operating sound index value being an index value of a magnitude of an operating sound obtained when the vehicle on-board component is operated independently, the coupling-associated operating sound index value being an index value of the magnitude of the operating sound obtained when the vehicle on-board component is operated with the vehicle on-board component coupled to the vehicle, and
estimating, by the execution device, using the trained neural network, a value of the output-side index value of the vehicle on-board component in which the input-side index value is a specified value in order to estimate the magnitude of the operating sound of the vehicle on-board component.
